(19) United States
(12) Patent Application Publication
(10) Pub. No.: US 2006/0253536 A1
(43) Pub. Date: Nov. 9, 2006

(54) Data transmission device

(76) Inventors: Katsuyoshi Fujiwara, Osaka (JP); Yuji Okamoto, Kyoto (JP); Naofumi Ueda, Kyoto (JP); Syouichirou Yoshiura, Nara (JP)

Correspondence Address: BIRCH STEWART KOLASCH & BIRCH, PO BOX 747, FALLS CHURCH, VA, 22040-0747, US

(21) Appl. No.: 10/550,895

(22) PCT Filed: Mar. 25, 2004
(86) PCT No.: PCT/JP04/04235

§ 371 Date: Sep. 27, 2005

(30) Foreign Application Priority Data
Mar. 28, 2003 (JP) 2003-092050

(51) Int. Cl. G06F 15/16

(52) U.S. Cl. 709/206

(57) ABSTRACT

Among unique addresses that are receiving ends of data, such as e-mail addresses, a partial address that is in common with a plurality of addresses is registered in a storing unit. For example, of an e-mail address containing a user name and a domain, the domain is used as the partial address. Thus, a data transmitting apparatus, such as an Internet facsimile apparatus, restricts data transmission for image data and the like only to addresses containing the partial address registered in the storing unit. In other words, data is transmitted only to addresses that have the same domain.

This application is the national phase under 35 U.S.C. §371 of PCT International Application No. PCT/JP2004/004235 which has an International filing date of Mar. 25, 2004 and designated the United States of America.

### TECHNICAL FIELD

The present invention relates to a data transmitting apparatus that transmits data, and more particularly, to a data transmitting apparatus such as an Internet facsimile apparatus that executes transmitting restriction of image data on the basis of an address as a receiving end.

### BACKGROUND ART

There are image transmitting apparatuses, such as facsimiles, each of which transmits and receives image data that has been read to and from an external apparatus (receiving end) through a communication path (telephone network). In recent years, a transmitting and receiving environment for images in which Internet facsimiles and the like for transmitting and receiving images through a communication network are used has been prepared. Moreover, there have been rapid progresses in forming document images into electronic data as well as in data sharing, and a workplace environment which utilizes such a network environment has been improved and prepared. Under these circumstances, as techniques for forming electronic data and for data sharing have progressed, it becomes necessary to prepare a protection (security) environment against data leakage and the like.

Conventionally, a means is installed in which a user authentication process is carried out by using a password (identification number) or the like so that, when as a result of collation, the input information is coincident with the authentication information that has been preliminarily registered, the use of an image transmitting apparatus is permitted thereafter; thus, by using the user authentication, unapproved use of the image transmitting apparatus has been restricted (for example, see Japanese Patent Application Laid Open No. 03-29461 (1991) and Japanese Patent Application Laid Open No. 04-157968 (1992)).

However, in such a case when collation information like a password is leaked, the image transmitting apparatus might be used without permission with the result that image information might be transmitted to an external apparatus. Moreover, in an attempt to directly input information of a receiving end, the user's unaccustomed operation might cause an input mistake etc., with the result that image data might be transmitted to an erroneous receiving end. Particularly, in recent years, the network environment has been improved, and techniques for forming electronic data have been improved, as described above, so that image information can be easily transmitted to an external apparatus; consequently, the above-mentioned problems have been recognized remarkably.

### DISCLOSURE OF THE INVENTION

The present invention has been made in view of the above-mentioned circumstances, and it is an object of the present invention to provide a data transmitting apparatus that is capable of preventing the possibility that data might be transmitted to the third person erroneously or with an ill intention, by preparing a structure in which, among unique addresses that are receiving ends of data, a partial address that is in common with a plurality of addresses is preliminarily registered so that data transmission is permitted with respect to only the addresses that contain the partial address.

A data transmitting apparatus according to the present invention, which transmits data is a data transmitting apparatus comprising: registering means for registering a partial address that is in common with a plurality of addresses in a storing unit, among unique addresses that are receiving ends of data; and restriction means for restricting data transmission to the addresses that contain the partial address registered in said storing unit.

The data transmitting apparatus according to the present invention is characterized in that said restriction means interrupts data transmission, when a received address contains no partial address registered in said storing unit.

The data transmitting apparatus according to the present invention is characterized by further comprising: input means for inputting an address of a receiving end, wherein said restriction means accepts only an address containing the partial address registered in the storing unit from the input means.

The data transmitting apparatus according to the present invention is characterized by further comprising: receiving address registering means for registering a partial address of a receiving address that is assigned thereto so as to receive data, in said storing unit, wherein said restriction means restricts data transmission only to the addresses that contain the partial address of the receiving address registered in the storing unit.

The data transmitting apparatus according to the present invention is characterized in that the addresses are e-mail addresses, and the partial address is a domain except for a user name.

The data transmitting apparatus according to the present invention is characterized in that the data transmitting apparatus is an Internet facsimile apparatus that transmits image data.

In the present invention, among the unique addresses that are receiving ends of data such as e-mail addresses, a partial address that is in common with a plurality of addresses is registered in the storing unit. For example, of each e-mail address that includes a user name and a domain, the domain is used as the partial address. Moreover, the data transmitting apparatus restricts data transmission only to addresses containing the partial address registered in the storing unit. In other words, data is transmitted only to the addresses having the same domain so that the transmission range is limited to the same work place or the like; thus, it becomes possible to strengthen the security system.

Moreover, in the present invention, an address is received from the input means used for inputting an address for a receiving end. In this case, the data transmitting apparatus accepts only addresses that contain the partial address registered in the storing unit from the input means. For example, an input of an address containing no registered partial address is inhibited, or an input of only the user name is accepted, and with respect to the partial address, an input of only the registered partial address is accepted. With this arrangement, the data transmission range is limited only to the preliminarily registered domain or the like so that the security system is strengthened.

Moreover, in the present invention, the data transmitting apparatus stores receiving addresses assigned thereto for receiving data, and also registers a partial address of the receiving addresses in the storing unit. Furthermore, the data transmitting apparatus restricts data transmission only to addresses containing the partial address of receiving addresses that have been registered in the storing unit. With this arrangement, the transmission range is limited only to addresses having the partial address of receiving addresses of the data transmitting apparatus itself, thus, it becomes possible to strengthen the security system.

### BRIEF DESCRIPTION OF THE DRAWINGS

FIG. 1 is a block diagram that shows a hardware structure of a data transmitting apparatus according to the present invention;

FIG. 2 is a schematic diagram that shows an operation unit and a display unit;

FIG. 3 is an explanatory view that shows an image of guide information displayed on the display unit;

FIG. 4 is an explanatory view that shows another image of guide information displayed on the display unit;

FIG. 5 is an explanatory view that shows a record layout of an address data file;

FIG. 6 is an explanatory view that shows still another image of guide information displayed on the display unit;

FIG. 7 is an explanatory view that shows still another image of guide information displayed on the display unit;

FIG. 8 is an explanatory view that shows still another image of guide information displayed on the display unit;

FIG. 9 is an explanatory view that shows still another image of guide information displayed on the display unit;

FIG. 10 is an explanatory view that shows still another image of guide information displayed on the display unit;

FIG. 11 is an explanatory view that shows still another image of guide information displayed on the display unit;

FIG. 12 is an explanatory view that shows the other image of guide information displayed on the display unit;

FIG. 13 is an explanatory view that shows a record layout of transmission permissible address data files;

FIG. 14 is an explanatory view that shows a record layout of a receiving address registered file;

FIG. 15 is an explanatory view that shows an image at the time of inputting a password for authentication;

FIG. 16 is an explanatory view that shows an image of a restriction setting wizard;

FIG. 17 is an explanatory view that shows an example in which a restriction is imposed at the time of inputting;

FIG. 18 is an explanatory view that shows an image of transmission restriction;

FIG. 19 is a flow chart that shows a sequence of the restricting processes according to the present invention;

FIG. 20 is a flow chart that shows a sequence of restricting processes according to the present invention;

FIG. 21 is a flow chart that shows a subroutine of the restricting processes; and

FIG. 22 is a flow chart that shows a subroutine of the restricting processes.

### BEST MODE FOR CARRYING OUT THE INVENTION

The following description will specifically explain the present invention, based on the drawings illustrating an embodiment thereof.

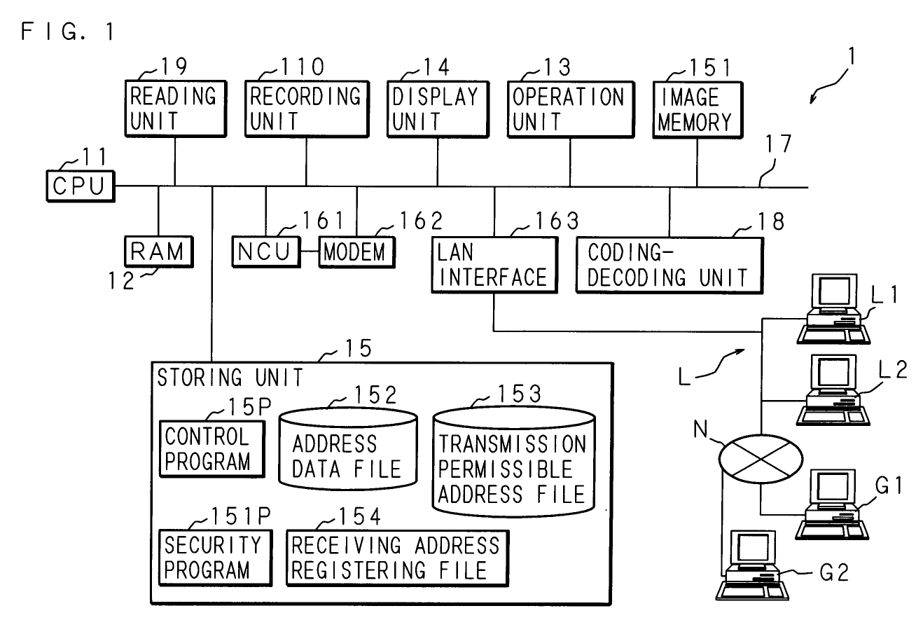

FIG. 1 is a block diagram that shows a hardware structure of a data transmitting apparatus according to the present invention. Here, the following description will exemplify a case in which an Internet facsimile apparatus 1 is used as the data transmitting apparatus 1; however, in addition to the apparatus that is provided with only the facsimile function, the apparatus may be a complex machine that has a function as a copying machine and a function as a printer in combination. Moreover, the present invention will be explained below on the assumption that the data to be transmitted is image data. In the Internet facsimile apparatus 1, a CPU (Central Processing Unit) 11, a reading unit 19, a recording unit 110, a display unit 14, an operation unit 13, a coding-decoding unit 18, a storing unit 15, a RAM (Random Access Memory) 12, an image memory 151, a modem 162, an NCU (Network Control Unit) 161 and a LAN interface 163 and the like are connected to one another through a bus 17.

The CPU 11, which is connected to the above-mentioned hardware units of the Internet facsimile apparatus 1 through the bus 17, controls those units, and also executes various software functions in accordance with a control program 15P and a security program 151P stored in the storing unit 15. The reading unit 19 reads a document by using a scanner in which, for example, CCDs (Charge Couple Devices) are utilized, and outputs the image data thus read. The recording unit 110, which is an electro photographic printing apparatus, is used for printing out data, such as image data received through facsimile communication, document image data read by the reading unit 19 and image data sent from personal computers L1 and L2 through the LAN interface 163.

The display unit 14, which is a display device such as a liquid crystal display, is used for displaying the operation state of the Internet facsimile apparatus 1 of the present invention, image data of a document that has been read for transmission, image data received from another facsimile apparatus, and image data sent from a personal computer or the like. The operation unit 13, serving as an input means, is provided with character keys required for operating the Internet facsimile apparatus 1 of the present invention, ten keys, shortened dial keys, one-touch dial keys, various function keys and the like. Here, the display unit 14 may comprise a touch panel so that one portion or the entire portions of the various keys of the operation unit 13 can be substituted thereby. The coding-decoding unit 18 code-compresses an image signal, and also decodes image data that has been code-compressed into the original image signal.

The storing unit 15, formed by a hard disk and the like, preliminarily stores a control program 15P and a security program 151P that are required for operations of the Internet facsimile apparatus 1 of the present invention. The security program 151P, which is a program that executes a restriction process (restriction means) or the like according to the present invention, is installed when desired by the user. Here, an address of a receiving end, inputted from the operation unit 13, is registered in an address data file 152 of the storing unit 15. In addition to these, the storing unit 15 also stores a transmission permissible address file 153 that stores addresses which are allowed to accept image data transmission and a receiving address registering file 154 that stores receiving addresses of the Internet facsimile apparatus 1. Although the address is a FAX number, an e-mail address or the like, the following explanation is given by exemplifying a case in which the address is prepared as an e-mail address.

The RAM 12, which is configured by a SRAM (Static Random Access Memory), a flash memory or the like, stores temporary data that is generated upon executing a software program. The image memory 151, which is configured by a DRAM (Dynamic Random Access Memory) or the like, stores data such as image data read for transmission, image data received from another facsimile apparatus and image data sent from a computer.

The modem 162, which is connected to the bus 17, is configured by a facsimile modem capable of facsimile communication. Moreover, the modem 162 is also directly connected to a NCU 161 connected to the bus 17. The NCU 161, which is a hardware device that opens and closes the communication line with the telephone line network, connects the modem 162 to the telephone line network, if necessary. Moreover, the Internet facsimile apparatus 1 is connected to computers L1 and L2 on a local area network and computers G1 and G2 connected to the Internet N, through the LAN interface 163. The Internet facsimile apparatus 1 transmits image data, read from the image memory 151, to any one of the computers L1, L2, G1 and G2 specified as a receiving end of the image data through the LAN interface 163.

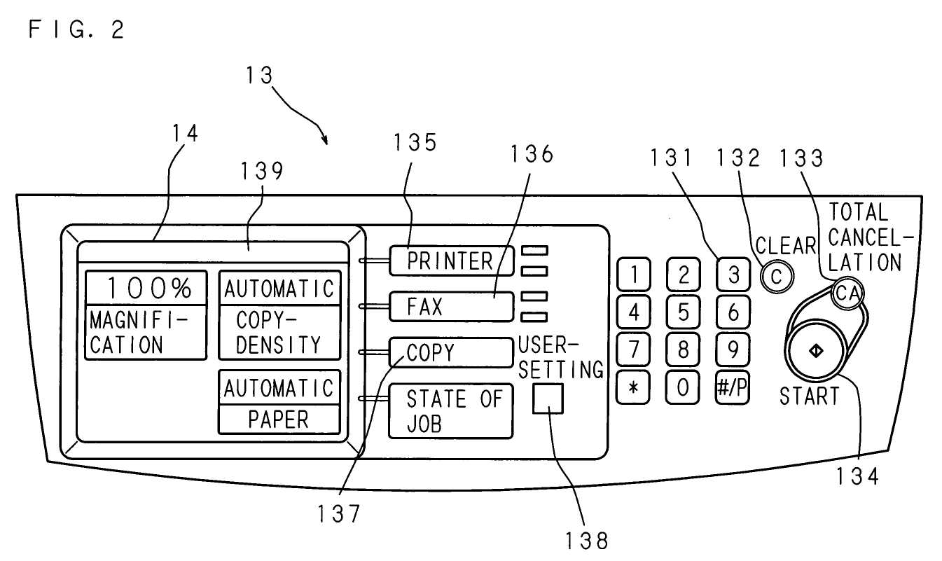

FIG. 2 is a schematic diagram that shows the outline of the operation unit 13 and the display unit 14. The display unit 14 is formed by a liquid crystal display, and a touch panel 139, which forms one portion of the operation unit 13, is laminated on the upper side thereof. Various setting operations, such as a copy-density setting operation, a paper selecting operation and a magnification setting operation, can be given through the touch panel 139 by the user's operations. On the right side of the operation unit 13, ten keys 131, a clear button 132 by which numeric value data or the like inputted through the ten keys 131 is revised, a start button 134 used for starting a reading process, transmitting process or the like of image data and a total cancellation button 133, which initializes settings of the number of copies, image quality and the like, or initializes a transmitting operation, a copying operation and the like of image data, are placed.

On the center portion adjacent to the touch panel 139 of the operation unit 13, a printer button 135, a FAX button 136, a copy button 137 and a “user-setting” button 138 are placed. As described earlier, the Internet facsimile apparatus 1 according to the present embodiment is provided with a printer function, a facsimile function and a copy function; therefore, when the user operates the printer button 135, the FAX button 136 or the copy button 137 depending on the desired usage, the Internet facsimile apparatus 1 is allowed to function as a printer, a facsimile apparatus or a copying machine. The “user-setting” button 138 is operated when registering, selecting and editing operations of an address of a receiving end, which will be described later, or various setting operations such as settings of date and time, are carried out.

When the operation unit 13 provided with the above-mentioned buttons is operated, a signal corresponding to the operated button is outputted to the CPU 11. In accordance with the control program 15P stored in the storing unit 15, the CPU 11 executes the process corresponding to the output from the operation unit 13, and reads required guide information from the storing unit 15, and outputs the information to the display unit 14.

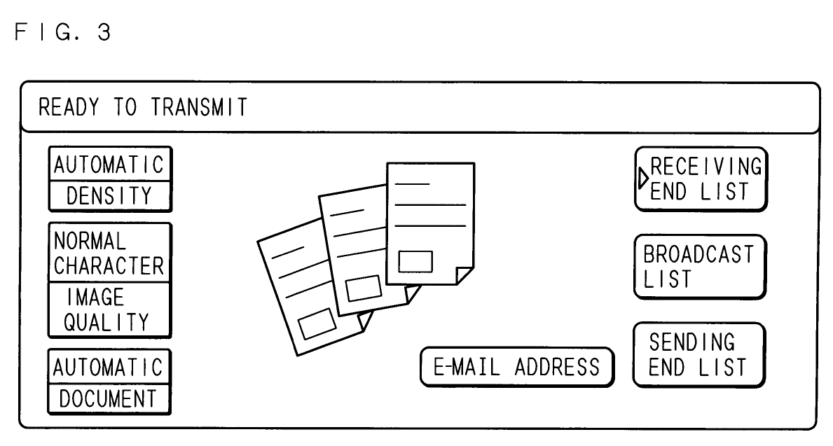

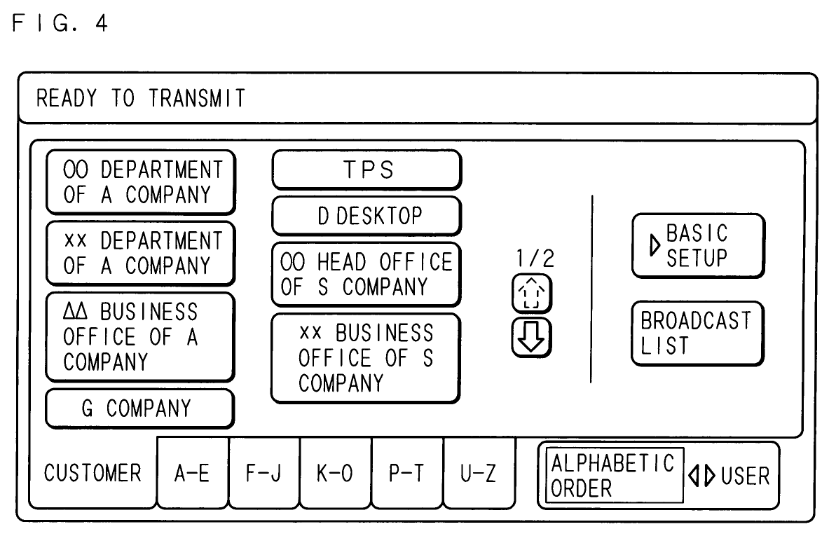

FIGS. 3 and 4 are explanatory views that show images of guide information displayed on the display unit 14. In FIG. 2, when the FAX button 136 is operated, a screen indicated by FIG. 3 is displayed. When “receiving end list” is operated, the CPU 11 reads names of receiving ends corresponding to addresses that have been registered (“∘∘ department of A company”, “□□ business office of A company”, “G company” and the like) from the address data file 152, and displays them as a list, as shown in FIG. 4. Here, when one of the receiving ends is selected through the touch panel 139, the corresponding address is read from the address data file 152, and image data, stored in the image memory 151, is transmitted to the corresponding address.

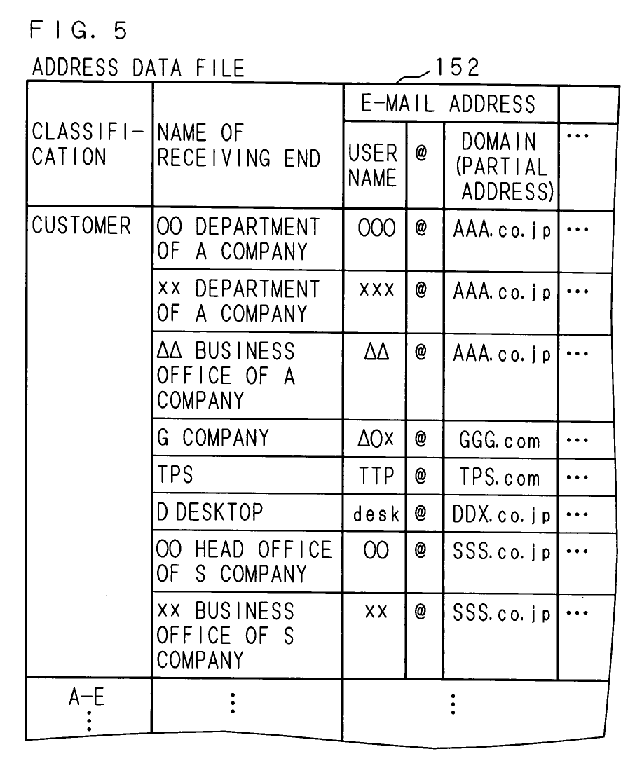

FIG. 5 is an explanatory view that shows a record layout of the address data file 152. As shown in this figure, e-mail addresses and the like are stored in association with names of receiving ends. The name of a receiving end that has been inputted is stored in a field of the name of a receiving end so as to allow easy recognition by the user. In an e-mail address field, a user name, @ and a partial address in common with a plurality of e-mail addresses (hereinafter, referred to as “domain”) are stored. With respect to the domain, for example, “AAA.co.jp” is stored as a partial address in common with e-mail addresses of, for example, ∘∘ department of A company, ×× department of A company and □□ business office of A company.

Here, the domain for G company is stored as “GGG.com”.

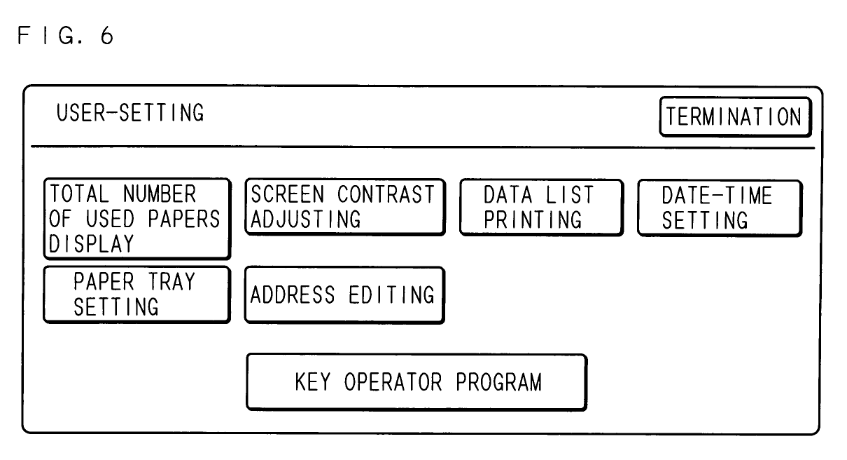

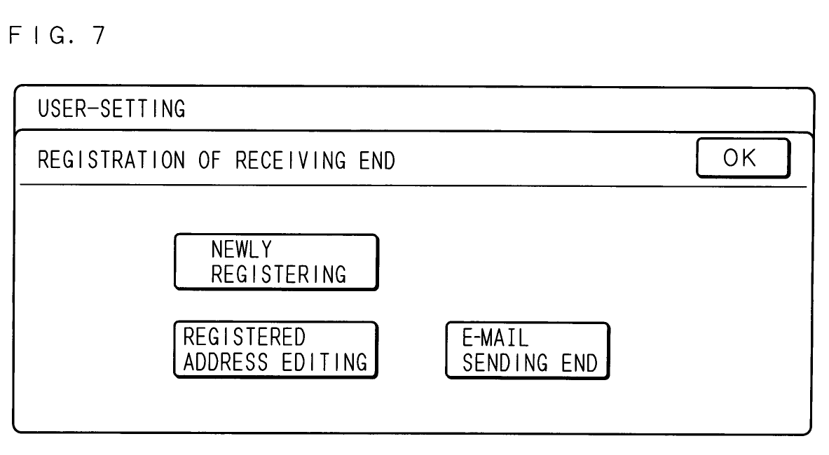

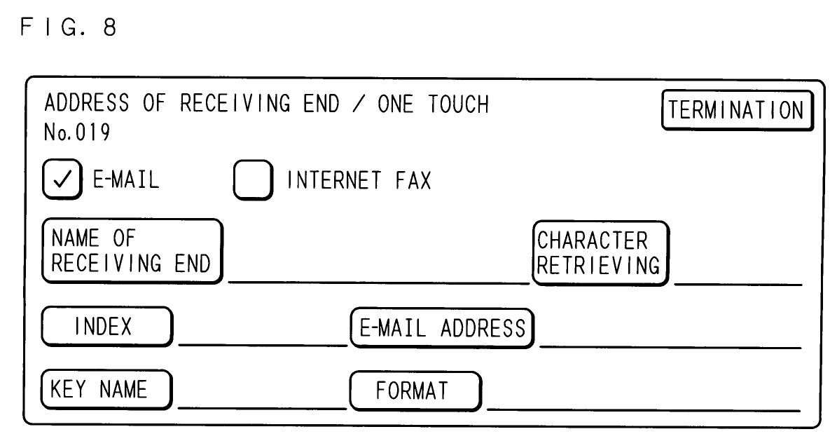

FIGS. 6 through 12 are explanatory views that show images of guide information displayed on the display unit 14. The following description will discuss newly registering processes for an e-mail address for a receiving end and editing processes for an address that has been registered. When “user setting” button 138 in FIG. 2 is pressed, the CPU 11 reads out a menu screen shown in FIG. 6 from the storing unit 15, and displays the screen. The menu screen displays items used for carrying out various setting operations, such as screen contrast adjusting, date-time setting and address editing. When the user operates the “address editing” button, the CPU 11 displays a screen shown in FIG. 7. As shown in FIG. 7, “newly registering” button and “registered address editing” button are displayed. Here, when the user operates the “newly registering” button, the CPU 11 displays a screen shown in FIG. 8.

The user inputs an e-mail address and the name and the like of a receiving end corresponding to the e-mail address by using the ten keys 131 and the like. Upon operation of “termination” button by the user, the inputted address and name of the receiving end are registered in the address data file 152, as shown in FIG. 5. In this case, of the inputted e-mail address, the CPU 11 stores the user name located prior to @ mark in a user name field, and also stores the portion succeeding the @ mark in a domain name field. Thus, when the “receiving end list” button is operated in FIG. 3, the name of the receiving end is read from the address data file 152 by the CPU 11, and displayed on the display unit 14 as shown in FIG. 4.

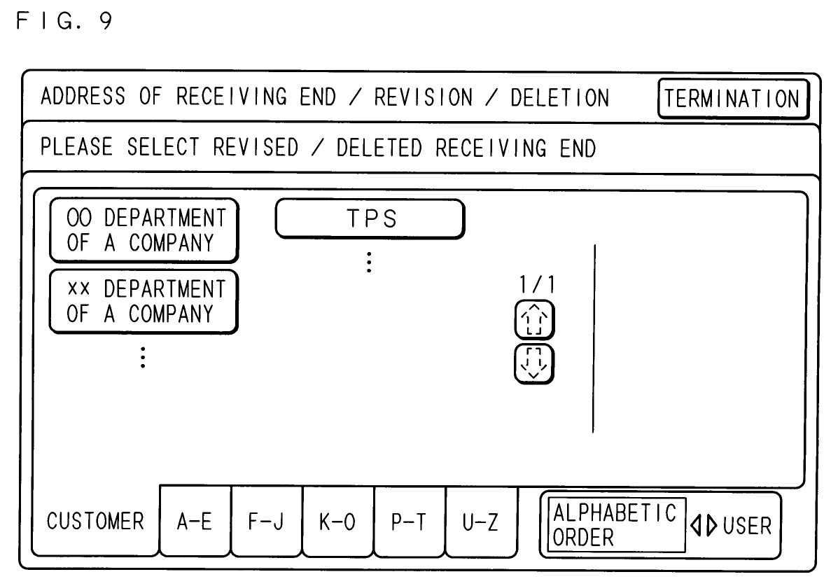

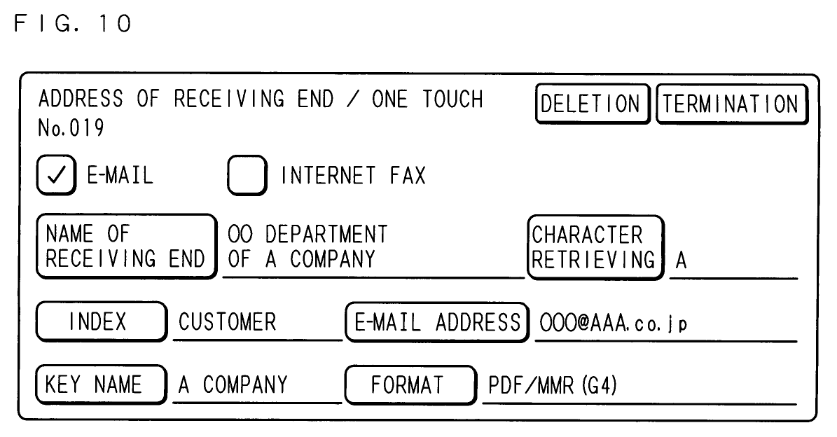

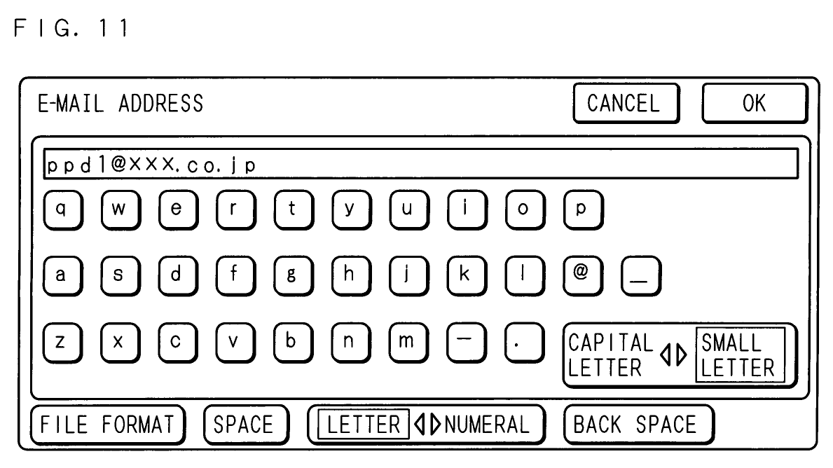

In contrast, when the “registered address editing” button is operated in FIG. 7, the CPU 11 displays a screen shown in FIG. 9. As shown in FIG. 9, the CPU 11 displays names of receiving ends read from the address data file 152 on the display unit 14 as a list, as shown in FIG. 11. The user selects a desired name of a receiving end to be edited. Thus, the CPU 11 reads the e-mail address and the like corresponding to the name of the receiving end from the address data file 152, and displays them as shown in FIG. 10. The user selects a desired item to be edited (name of a receiving end, e-mail address, index, retrieving character or the like), and inputs the contents of edition through the ten keys 131. The CPU 11 stores the data that has been edited in the address data file 152.

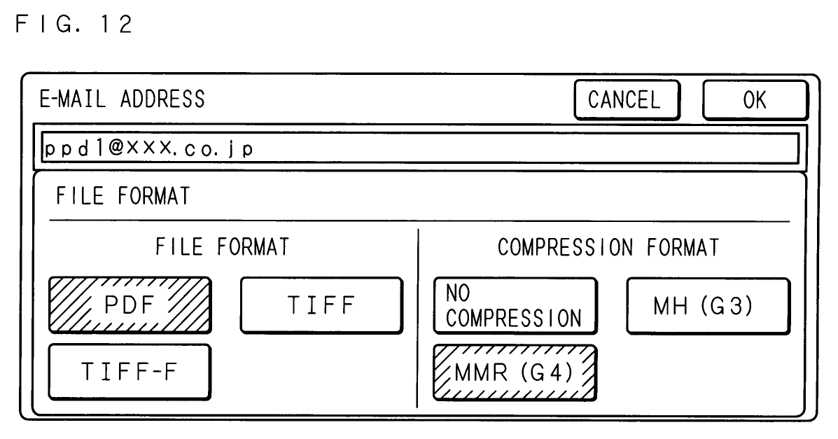

In contrast, when “E-MAIL address” button is operated so as to input an address that has not been registered in FIG. 3, a screen used for inputting an e-mail address shown in FIG. 11 is displayed. The user inputs an e-mail address of a receiving end through the ten keys 131. After the input of the e-mail address, the user operates “OK” button through the touch panel 139. When “OK” button is operated, the CPU 11 displays a screen shown in FIG. 12. In FIG. 12, the user is allowed to select a file format and a compression format of image data to be transmitted. With respect to the file format, selection is made from PDF (Personal Document Format) (Registered Trademark) and TIFF (Tagged Image File Format) (Registered Trademark) and the like. Moreover, with respect to the compression format, in addition to the case in which no compression is carried out, selection is made from compression formats, such as MH (G(Group)3) and MMR (G(Group)4). When the user selects the file format and the compression format, and then operates “OK” button, the CPU 11 reads image data from the image memory 151, and after carrying out a converting process of the file format and a compression process on the image data, transmits the resulting image data to the inputted e-mail address.

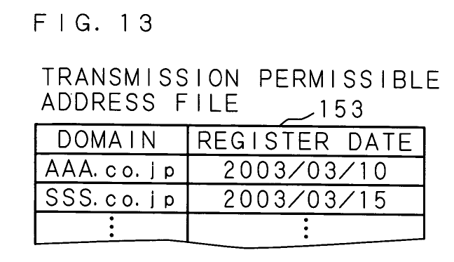

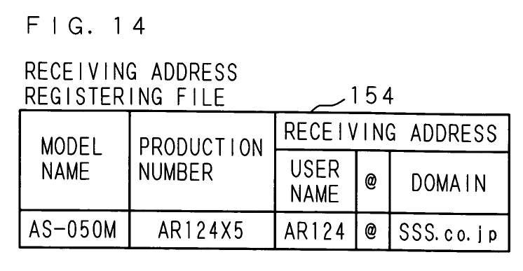

The following description will discuss a transmission restricting process of image data. FIG. 13 is an explanatory view that shows a record layout of a transmission permissible address file, and FIG. 14 is an explanatory view that shows a record layout of a receiving address registering file 154. As shown in FIG. 13, the transmission permissible address file 153 stores a domain that can be transmitted and a register date of the registered domain. For example, in the present embodiment, each of “AAA.co.jp” of A Company and “SSS.co.jp” of S company is stored as the domain to which image data can be transmitted. Moreover, in the receiving address registering file 154 shown in FIG. 14, a user name (AR124) of a receiving address, @, and the domain (SSS.co.jp) are registered. In addition to these, the model name (AS-050M) and the production number (AR124×5) etc. of the Internet facsimile apparatus 1 are stored. The following description will discuss processes used for registering an address the transmission of which is permitted.

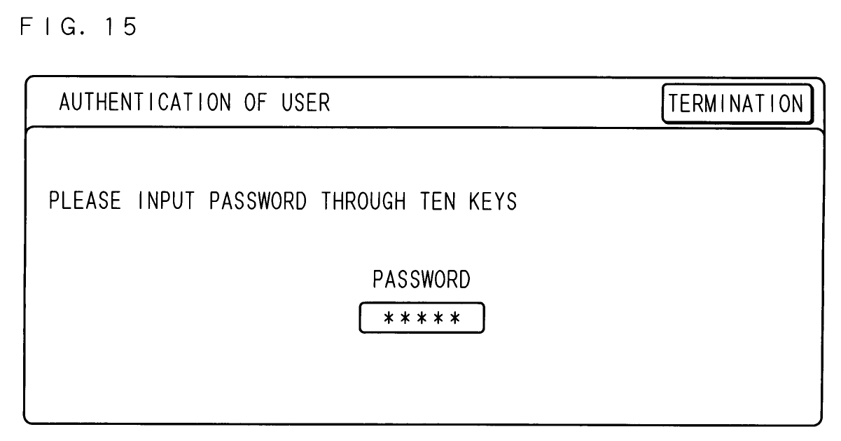

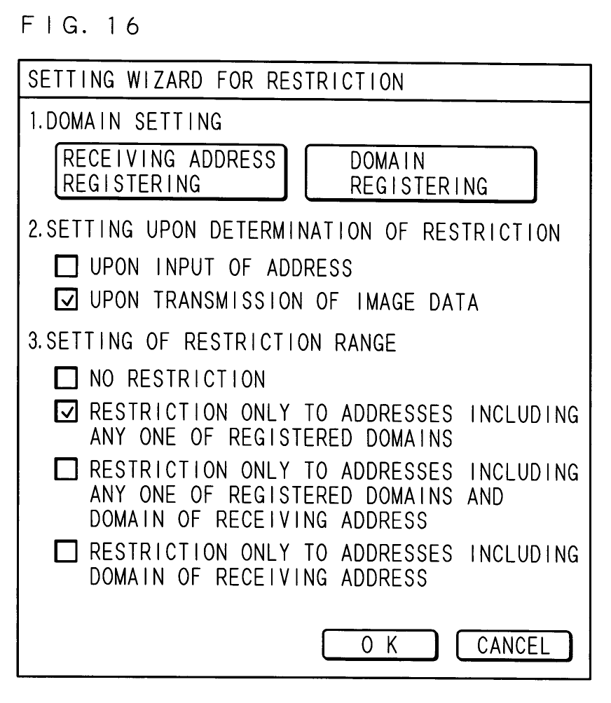

When the user operates “key operator program” button on the user setting screen in FIG. 6, an authentication screen as shown in FIG. 15 is displayed. FIG. 15 is an explanatory view that shows images that explain a password inputting operation for authentication. A screen that urges an input of a password is displayed on the authentication screen. The user inputs a password through the ten keys 131. The CPU 11 compares the inputted password with the corresponding password preliminarily stored in the storing unit 15, and only when the inputted password is coincident therewith, displays a setting wizard screen for restriction as shown in FIG. 16. In the present embodiment, the authentication is carried out through the password; however, the authentication may be carried out by using biological information such as a fingerprint.

FIG. 16 is an explanatory view that shows an image of the setting wizard for restriction. The transmission restriction is constituted by (1) domain setting, (2) setting upon determination of restriction and (3) setting of the restriction range. In the (1) domain setting, a registering operation of a receiving address of the Internet facsimile apparatus 1 is carried out and a domain to which the transmission is permitted is registered. When the user operates “receiving address registering” button in FIG. 16, a screen used for inputting a receiving address of the Internet facsimile apparatus 1 is displayed, and the user inputs a receiving address through the ten keys 131 and the like. The CPU 11 registers the inputted receiving address in a receiving address registering file 154 as shown in FIG. 14. In the present embodiment, the receiving address is registered as “AR124@SSS.co.jp” and the receiving domain is registered as “SSS.co.jp”.

Moreover, when the user operates “domain registering” button, a domain inputting screen is displayed, and the user inputs a domain the transmission of which is permitted by using the ten keys 131 and the like. The CPU 11 registers the inputted domain in the transmission permissible address file 153 as shown in FIG. 13. In the present embodiment, “AAA.co.jp” and “SSS.co.jp” are registered as domains the transmissions of which are permitted. Successively, the sequence proceeds to the (2) setting upon determination of restriction. In the setting upon determination of restriction, the CPU 11 determines as to what timing the transmission restriction of image data is set in. When the user selects the address input timing, the CPU 11 determines whether or not the transmission restriction is applied at the time when the user inputs an address.

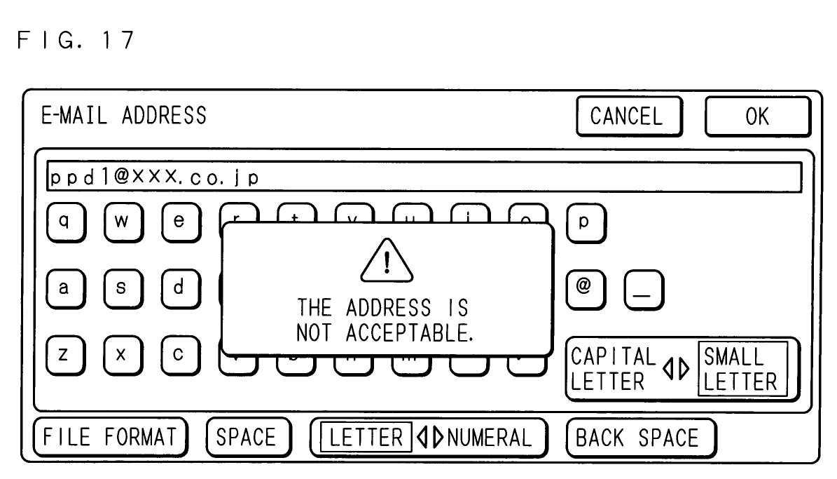

FIG. 17 is an explanatory view that shows an example in which the restriction is applied upon inputting. For example, suppose that only “AAA.co.jp” and “SSS.co.jp” are set as domains the transmissions of which are permitted. When upon inputting a receiving end through the ten keys 131, the user inputs a domain corresponding to @ mark and thereafter, the CPU 11 determines whether or not the inputted domain is coincident with any one of domains registered in the transmission permissible address file 153. When the CPU 11 determines that no coincidence is obtained, it displays a warning screen as shown in FIG. 17. In the present example, since the user uses the ten keys 131 to input “X” other than any one of the domains registered in the transmission permissible address file 153, the warning screen is displayed. Here, the restriction at the time of inputting simply shows one example, and in addition to this restriction, the restriction may be given by forcefully making the user select either of the domains “AAA.co.jp” and “SSS.co.jp” registered in the transmission permissible address file 153, upon inputting a domain. Moreover, the restriction may be given by allowing the user to select only the domains registered in the transmission permissible address file 153 upon selection of a receiving end in FIG. 4.

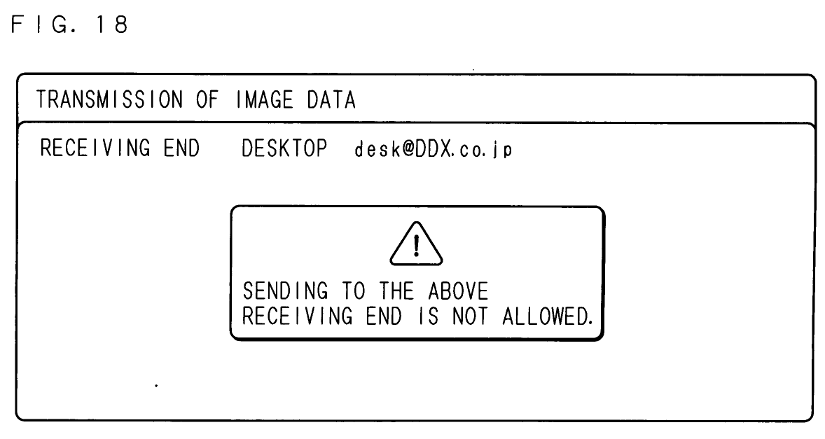

Moreover, in the setting upon determination of restriction in FIG. 16, when the user sets “upon transmission of image data”, the CPU 11 compares the domain of an address of a receiving end with the domains registered in the transmission permissible address file 153 upon transmission of image data, and only when coincidence is made, transmits image data. FIG. 18 is an explanatory view that shows an image of transmission restriction. Upon transmission of image data, the CPU 11 compares the domain of an address of a receiving end with the domains registered in the transmission permissible address file 153, and when no coincidence is made, reads a warning screen shown in FIG. 18 from the storing unit 15 and displays the screen.

In FIG. 16, upon setting the restricting range, the user selects any one of items including “no restriction”, “restriction only to addresses including any one of registered domains”, “restriction only to addresses including any one of registered domains and a domain of a receiving address” and “restriction only to addresses including a domain of a receiving address”. When image data is transmitted to all the receiving ends without particular restrictions, the item “no restriction” is selected. In other words, the item “no restriction” can be selected under an environment in which high security is not particularly required.

The item “restriction only to addresses including any one of registered domains” is selected when the transmission is restricted to only the addresses including any one of domains registered in the transmission permissible address file 153 shown in FIG. 13. Upon selection of this item, the CPU 11 compares the input with domains registered in the transmission permissible address file 153 when an address is inputted or when image data is transmitted, so as to carry out the corresponding restriction process. In the present embodiment, when the address of a receiving end contains “AAA.co.jp” or “SSS.co.jp”, the transmission is permitted.

The item “restriction only to addresses including any one of registered domains and a domain of a receiving address” is selected when the transmission is restricted only to addresses containing any one of domains registered in the transmission permissible address file 153 shown in FIG. 13 as well as to addresses containing a domain of a receiving address registered in the receiving address registering file 154 shown in FIG. 14. Upon selection of this item, the CPU 11 compares the input with the domains registered in the transmission permissible address file 153 as well as with the domain registered as the receiving address, when an address is inputted or when image data is transmitted, so as to carry out the corresponding restriction process. In the present embodiment, when the address of a receiving end contains “AAA.co.jp” or “SSS.co.jp”, the transmission is permitted.

The item “restriction only to addresses including a domain of a receiving address” is selected when the transmission is restricted only to addresses containing a domain for a receiving address that is registered in the receiving address registering file 154 shown in FIG. 14. Upon selection of this item, the CPU 11 compares the address of a receiving end with the domain registered in the receiving address when an address is inputted or when image data is transmitted, so as to carry out the corresponding restriction process. In the present embodiment, only when the address of a receiving end contains “SSS.co.jp”, the transmission is permitted. After all the settings have been completed, the user operates “OK” button through the touch panel 139. Thus, the CPU 11 stores the inputted restriction setting in the storing unit 15 and executes the restriction processes.

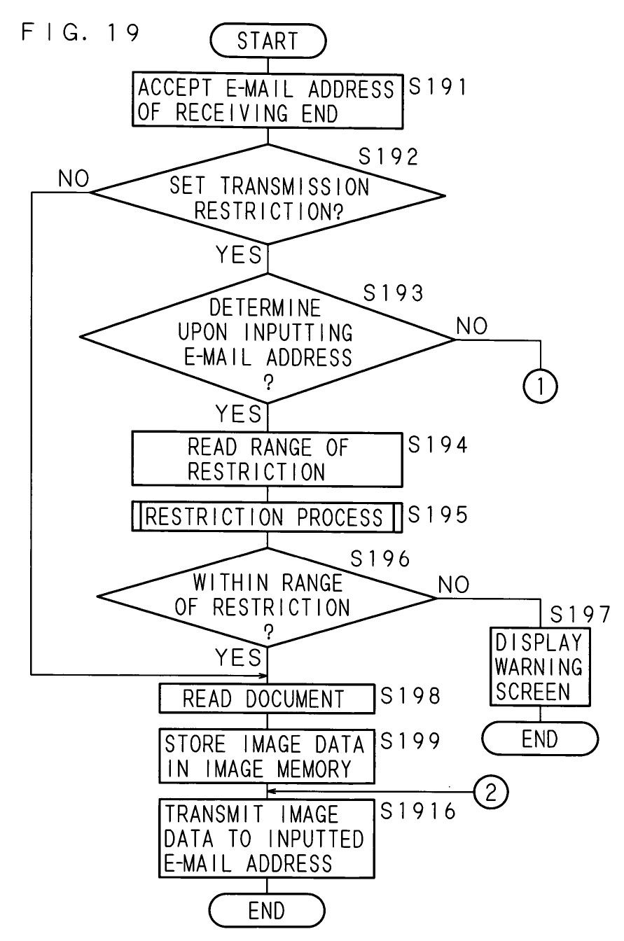

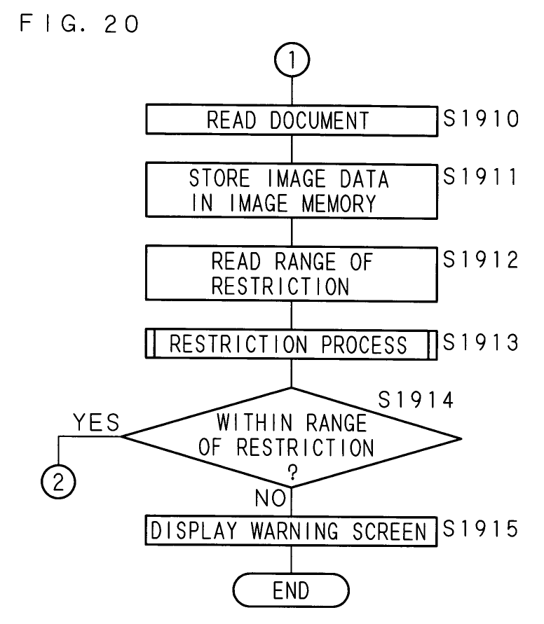

In the above-mentioned hardware structure, referring to flow charts, the following description will discuss the sequences of restriction processes according to the present invention. FIGS. 19 and 20 are flow charts that show the sequences of restriction processes according to the present invention. First, the CPU 11 accepts an input of an e-mail address of a receiving end of image data through the operation unit 13 (step S191). More specifically, the CPU 11 displays names of receiving ends read from the address data file 152 on the display unit 14 as shown in FIG. 4, and accepts a selection of a receiving end, or displays a screen used for directly inputting an e-mail address as shown in FIG. 11 and accepts an input of an e-mail address. The following description will discuss a mode shown in FIG. 11, that is, a mode in which an e-mail address is directly inputted.

Successively, referring to the storing unit 15, the CPU 11 determines whether or not any transmission restriction has been set through the setting of restriction as explained in FIG. 16 (step S192). When a transmission restriction has been set (YES in step S192), the CPU 11 determines whether or not the timing of determination of the restriction is set as the timing of inputting an e-mail address through the setting of restriction as explained in FIG. 16 (step S193). When the CPU 11 determines that the timing of determination is set in the storing unit 15 as the timing of inputting an e-mail address (YES in step S193), it carries out the reading process of the range of restriction (step S194). In other words, the CPU 11 reads out the setting of the range of restriction set in FIG. 16 from the storing unit 15 (step S194).

Thus, the CPU 11 executes the restriction process (step S195). Here, the restriction process will be described later in detail. In contrast, when the CPU 11 determines that the timing of determination of restriction is not set as the timing of inputting an e-mail address (NO in step S193), that is, when the CPU 11 determines that the timing of determination of restriction is stored in the storing unit 15 as the timing of transmitting image data, the CPU 11 drives the reading unit 19 to carry out a reading process of a document (step S1910). The CPU 11 stores digital data of image data converted by the AD conversion unit, not shown, in the image memory 151 (step S1911). Successively, the CPU 11 carries out a reading process of the range of restriction (step S1912) to execute the restriction process (step S1913).

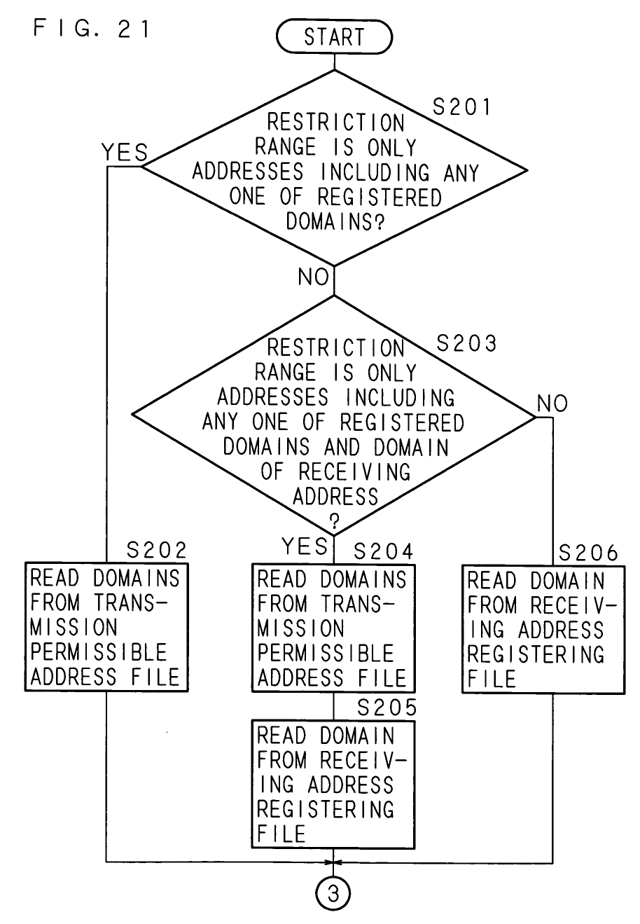

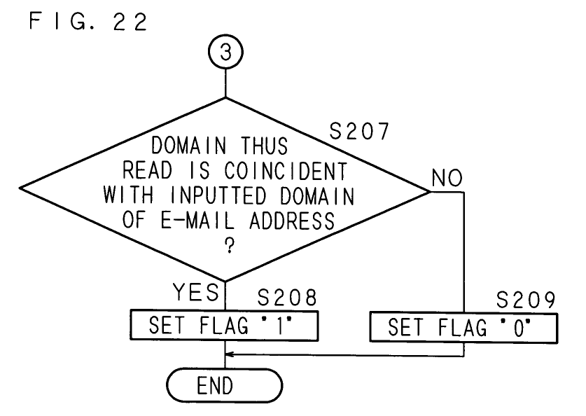

The following description will discuss a subroutine of the restriction process. FIGS. 21 and 22 are flow charts that show the subroutine of the restriction process. The CPU 11 determines whether or not the range of restriction thus read corresponds to the item “restriction only to addresses including any one of registered domains” (step S201). In other words, the CPU 11 determines whether or not the user has restricted the transmission range to e-mail addresses including any one of domains registered in the transmission permissible address file 153 in the restriction setting wizard shown in FIG. 16. When the CPU 11 determines that the restriction range corresponds to the item “restriction only to addresses including any one of registered domains” (YES in step S201), it reads out the registered domains from the transmission permissible address file 153 (step S202).

In contrast, when the CPU 11 has determined that the restriction range does not correspond to the item “restriction only to addresses including any one of registered domains” in step S201 (NO in step S201), it determines whether or not the restriction range corresponds to the item “restriction only to addresses including any one of registered domains and a domain of a receiving address” (step S203). When the CPU 11 determines that the restriction range corresponds to the item “restriction only to addresses including any one of registered domains and a domain of a receiving address” (YES in step S203), the CPU 11 determines whether or not the user has restricted the transmission range to e-mail addresses including any one of domains registered in the transmission permissible address file 153 and a domain of the Internet facsimile apparatus 1 itself registered in the receiving address registering file in the restriction setting wizard shown in FIG. 16.

When the CPU 11 determines that the restriction range corresponds to the item “restriction only to addresses including any one of registered domains and a domain of a receiving address” (YES in step S203), it reads out the registered domains from the transmission permissible address file 153 (step S204). Moreover, the CPU 11 also reads out the domain registered in the receiving address registering file 154 (step S205). When the CPU 11 has determined that the restriction range does not correspond to the item “restriction only to addresses including any one of registered domains and a domain of a receiving address” in step S203 (NO in step S203), it reads out the domain registered in the receiving address registering file 154 (step S206).

The CPU 11 determines whether or not the domain thus read is coincident with a domain of an e-mail address inputted from the operation unit 13 (step S207). When the CPU 11 determines that these are coincident with each other (YES in step S207), it sets a flag “1” at the RAM 12 (step S208); in contrast, when it determines that these are not coincident (NO in step S207), it sets a flag “0” at the RAM 12 (step S209). Then, the CPU 11 returns the sequence of processes to the main routine.

In step S196 in FIG. 19, the CPU 11 determines whether or not the restriction range is kept (step S196). In other words, the CPU 11 determines whether the flag set in the RAM 12 is “1” or “0”. When it is determined that the restriction range is not kept (NO in step S196), that is, when the CPU 11 determines that the flag “0” is set in the RAM 12, the CPU 11 displays a warning screen on the display unit 14 as shown in FIG. 17 (step S197).

In contrast, when it is determined that the restriction range is kept (YES in step S196), that is, when the CPU 11 determines that the flag “1” is set in the RAM 12 and that the transmission restriction is not set in step S192 (NO in step S192), the CPU 11 drives the reading unit 19 to read a document (step S198). The CPU 11 stores digital data of image data that has been converted in an AD conversion unit, not shown, in the image memory 151 (step S199).

In step S1914 also, the CPU 11 determines whether or not the restriction range is kept (step S1914). In other words, the CPU 11 determines whether the flag set in the RAM 12 is “1” or “0”. When it is determined that the restriction range is not kept (NO in step S1914), that is, when the CPU 11 determines that the flag “0” is set in the RAM 12, the CPU 11 displays a warning screen on the display unit 14 as shown in FIG. 18 (step S1915).

In contrast, in the case when it is determined that the restriction range is kept (YES in step S1914), that is, in the case when the CPU 11 determines that the flag “1” is set in the RAM 12, the CPU 11, in step S199 and thereafter, the CPU 11 transmits image data stored in the image memory 151 to the inputted e-mail address (step S1916).

### INDUSTRIAL APPLICABILITY

As described above in detail, in the present invention, among unique addresses that are receiving ends of data, such as e-mail addresses, a partial address that is in common with a plurality of addresses is registered in a storing unit. Thus, a data transmitting apparatus restricts data transmission only to those addresses including the partial address registered in the storing unit. In other words, since data is transmitted only to those addresses having the same domain, the transmission range is restricted to the same workplace or the like so that it becomes possible to strengthen the security system.

Moreover, in the present invention, an address is received from an input means used for inputting an address of a receiving end. In this case, the data transmitting apparatus accepts only addresses including the partial address registered in the storing unit from the input means. With this arrangement, the data transmission range is restricted to a domain or the like that has been preliminarily registered so that it becomes possible to strengthen the security system.

Furthermore, in the present invention, the data transmitting apparatus stores a receiving address that is assigned thereto so as to receive data, and also registers a partial address of the receiving address in the storing unit. Here, the data transmitting apparatus restricts the data transmission only to those addresses containing the partial address of the receiving address registered in the storing unit. With this arrangement, since the transmission range is restricted only to those addresses having the partial address of the receiving address for the data transmitting apparatus, it becomes possible to further strengthen the security system; thus, the present invention exerts superior effects.

1-6. (canceled)

7. A data transmitting apparatus which transmits data, comprising a controller capable of performing operations of:
registering a partial address that is in common with a plurality of addresses in a storing unit, among unique addresses that are receiving ends of data; and
restricting data transmission to the addresses that contain the partial address registered in said storing unit.

8. The data transmitting apparatus according to claim 7, wherein said controller is further capable of performing an operation of interrupting data transmission, when a received address contains no partial address registered in said storing unit.

9. The data transmitting apparatus according to claim 7, further comprising:
an input unit for inputting an address of a receiving end, wherein
said controller is further capable of performing an operation of accepting only an address containing the partial address registered in the storing unit from the input unit.

10. The data transmitting apparatus according to claim 7, wherein said controller is further capable of performing operations of:
registering a partial address of a receiving address that is assigned thereto so as to receive data, in said storing unit; and
restricting data transmission only to the addresses that contain the partial address of the receiving address registered in the storing unit.

11. The data transmitting apparatus according to claim 7, wherein said addresses are e-mail addresses, and said partial address is a domain except for a user name.

12. The data transmitting apparatus according to claim 7, which is an Internet facsimile apparatus that transmits image data.

13. A data transmitting apparatus which transmits data, comprising:
registering means for registering a partial address that is in common with a plurality of addresses in a storing unit, among unique addresses that are receiving ends of data; and
restriction means for restricting data transmission to the addresses that contain the partial address registered in said storing unit.

14. The data transmitting apparatus according to claim 13, wherein said restriction means interrupts data transmission, when a received address contains no partial address registered in said storing unit.

15. The data transmitting apparatus according to claim 13, further comprising:
input means for inputting an address of a receiving end, wherein
said restriction means accepts only an address containing the partial address registered in the storing unit from the input means.

16. The data transmitting apparatus according to claim 13, further comprising:
receiving address registering a partial address of a receiving address that is assigned thereto so as to receive data, in said storing unit, wherein
said restriction means restricts data transmission only to the addresses that contain the partial address of the receiving address registered in the storing unit.

17. The data transmitting apparatus according to claim 13, wherein said addresses are e-mail addresses, and said partial address is a domain except for a user name.

The data transmitting apparatus according to claim 13, which is an Internet facsimile apparatus that transmits image data.
